(19) United States
(12) Patent Application Publication
(10) Pub. No.: US 2002/0153510 A1
(43) Pub. Date: Oct. 24, 2002

(54) Alkali earth aluminate silicate photoluminescent pigment which is activated by rare - earth elements

(76) Inventors: Zhao Sun, Shandong (CN); Shi Min Su, Shandong (CN); Yu Jun Zhang, Shandong (CN); Zhong Li Zhu, Shandong (CN)

Correspondence Address: Robert H. Bachman, BACHMAN & LaPOINTE, P.C., Suite 1201, 900 Chapel Street, New Haven, CT, 06510-2802, US

(21) Appl. No.: 09/876,476

(22) Filed: Jun. 7, 2001

(30) Foreign Application Priority Data
Apr. 18, 2001 (GB) 0109529.8

(51) Int. Cl. C01B 33/26; C09K 11/08

(52) U.S. Cl. 252/301.4 P; 423/263; 423/328.1; 252/301.4 F; 252/301.4 H

(57) ABSTRACT

An alkali earth aluminate-silicate photoluminescent pigment which is activated by rare-earth elements according to the invention has excellent luminescent properties such as high initial intensity and long afterglow time. The pigment may readily be used in the manufacture of luminescent plastics; rubbers, coatings and ceramic glazes because it appears neutral in aqueous medium and the sinters are easily crushed into powder. The pigment has the composition formula of MO.aAl₂O₃bSiO₂cL:fX, in which MO is represented by at least one oxide selected from alkali earth metals such as SrO, CaO and MgO; L is a mineraliser selected from minerals, X is an activator selected from rare-earth elements; and a, b, c and f are variable factors having values in mole. The pigment is produced by firing selected ingredient materials in a controlled environment of a reducing atmosphere, filled with selected gases or elements, at a temperature of 1200-1450° C. for 2-4 hours to produce a sinter; and the sinter is finally produced into photoluminescent pigments.

### FIELD OF THE INVENTION

This invention relates to the field of material science and is particularly related to a kind of alkali earth aluminate-silicate material having long photoluminescent afterglow properties which are activated by the rare-earth elements.

BACKGROUND OF THE INVENTION

In recent years of development, the alkali earth aluminate photoluminescent materials activated by rare-earth elements were found to be favoured by most people for excellent properties and benefits such as, high initial luminescent intensity, long afterglow time and non-radioactivity. A few introductory reports and patents have been published on such photoluminescent materials. Chinese Patent Application No. CN 1126746A relates to a kind of alkali earth aluminate photoluminescent material that is activated by Eu, Ce, Tb and Dy. Chinese Patent Application No. CN 1115779A, relates to another kind of luminescent material that is activated by the rare-earth elements (Eu, Ce, Tb, Dy) and non rare-earth elements (Sb, Sn). Chinese Patent Application No. CN 1152018A relates to a kind of photoluminescent material and a preparation method for this material, with the general formula M.N.Al₂₋ₓBₓO₂, in which M indicates an alkali earth metal—it is normally strontium (Sr); N indicates a rare-earth element—it is normally europium (Eu), and in which 0.1≦X≦1. Chinese Patent Application No. CN1132777A, U.S. Pat. No. 5,424,006, U.S. Pat. No. 5,686,022, EP 0622440 and EP 0710709 A1, relate to an alkali earth aluminate luminescent material and its preparation method. Chinese Patent Application No. CN 1194292 relates to a kind of silicate photoluminescent material and its preparation method, its main formula being aMO.bM′O.cSiO₂.dR:Euₓ, Ln_{y} in which M is at least one element selected from strontium (Sr), calcium (Ca), barium (Ba), zinc (Zn); and M′ is at least one element selected from magnesium (Mg), cadmium (Cd), beryllium (Be). Ln is selected from the rare-earth elements or transition elements. This luminescent material emits light in the optical spectrum where its peak values are in the 450-580 nm region. The colours of the light shown, with long afterglow, are blue, blue-green, green, green-yellow, and yellow etc.

For the above-mentioned alkaline earth aluminate luminescent materials activated by rare-earth elements, their sinters are very hard to crush. These luminescent materials appear alkaline in the aqueous medium because of the high alkaline metal oxide content, and also cannot be used directly in many cases. For example, when these luminescent materials are used directly in plastics or rubber, the luminescent products are susceptible to blacken or become grey. They often engender hydrolysis, causing precipitation when used in aqueous coating. It is difficult to form a stable coating system. When they are used in low-temperature ceramic paper or colour glass paper, it is also difficult to obtain a smooth surface because of their high aluminium oxide content. Furthermore, the luminescent intensity and afterglow time of the silicate luminescent material activated by rare-earth elements are much lower than those of the aluminate luminescent material are.

### SUMMARY OF THE INVENTION

The object of this invention is to overcome the shortcomings of all of the above-listed technologies available at present, by providing a preparation and production method of a new kind of alkali earth aluminate-silicate luminescent material which is activated by rare-earth elements and which is easy to handle and has many excellent qualities.

According to one aspect of the present invention there is provided an alkali earth aluminatesilicate photoluminescent material which is activated by rare-earth elements and which has the composition MO.aAl₂O₃bSiO₂cL:fX, in which MO is at least one oxide from the selection SrO, CaO, MgO and BaO; L is a mineraliser, X is a rare earth element activator; a, b, c and f are variable factors of Al₂O₃,SiO₂, mineraliser L and activator X and are presented in terms of mole and have a mole ratio relationship with MO in which the mole value of MO=1, the variable factors being:

0.3≦(a+b)≦3, b=(0.01˜2)a, c=0.02˜0.5, f=0.001˜0.05.

Preferably, the rare-earth element activator X is europium oxide and at least one oxide selected from a selection of dysprosium oxide, cerium oxide, neodymium oxide, praseodymium oxide, samarium oxide, terbium oxide, holmium oxide, erbium oxide, thulium oxide and ytterbium oxide, having a mole ratio relationship of 1:(0.5˜5).

The mineraliser L of the above-mentioned material may be alkaline halide and/or an ammonium halide salt and/or ammonium phosphates preferably ammonium chloride, ammonium bromide and ammonium biphosphate.

Another aspect of the invention provides a method of preparing the above-mentioned aluminatesilicate photoluminescent material which is activated by rare-earth elements, said method including the steps of selecting and weighing an alkali earth metal carbonate or oxide, aluminium oxide or aluminium hydrate and silica powder, in which 0.3≦(a+b)≦3, b=(0.01˜2)a, c=0.02˜0.5, f=0.001˜0.05, together with elements for the mineraliser L and activator X, mixing the ingredients and then putting the mixture into a crucible to fire at a temperature range of 1200 ˜1450° C. for 2-4 hours under a reducing atmosphere, to yield a sinter, the sintered material then being crushed, ground and graded, washed with de-ionised water, diluted hydrochloric acid solution or alcohol and dried by heat, finally to produce an alkali earth aluminate-silicate photoluminescent pigment which is activated by rare-earth elements.

Preferably, the reducing atmosphere is a selection and/or combination of gases or substances such as hydrogen, ammonia, nitrogen with hydrogen and carbon granules.

By following the method according to the invention, it is possible successfully to manufacture a novel type of photoluminescent material pigments by choosing a suitable combination of aluminate-silicate matrix materials, rare-earth elements for the activator, and the right materials for the mineraliser.

The produced sinter is easy to crush in photoluminescent pigment production. The pigment appears neutral in water. With 15 seconds of light excitation, the luminescent intensity of produced pigment materials could reach 1800 med/m², and its afterglow time can last for more than 12 hours. The main peaks of its luminance could be seen in the variable range between 440 nm to 510 nm in the optical spectrum, subject to different choices of ingredients. The luminescent intensity and afterglow time of the said photoluminescent materials have been measured in accordance with the requirements of DIN67510.

Compared with the above listed technology available at present, the pigment material according to the present invention is far superior in terms of manufacture, is convenient to use and very easy to handle. The problems encountered in luminescent plastic and rubber production as described above are overcome in methods of injection, extrusion and filming. Many quality products such as luminescent plastic, luminescent rubber, luminescent ceramic glaze, luminescent enamel glaze, luminescent colour paper, luminescent coatings, etc can be easily produced by means of the photoluminescent pigments of the present invention.

### DESCRIPTION OF PREFERRED EMBODIMENTS

The invention will now be explained in greater detail with reference to the following examples but it should be noted that the scope of pigment categories is not limited by these examples.

For the ease of explanation, all following examples use the same composite formula described above for the alkali earth aluminate-silicate photoluminescent material pigments activated by rare-earth elements

MO.aAl₂O₃.bSiO₂cL:fX,

In which MO is SrO and/or CaO, or BaO or MgO; the terms Al₂O₃ and SiO₂ may also vary; materials for the mineraliser L and rare-earth element activator X are individually selected, with unique mole ratio relationships in each case.

### EXAMPLE I

### The Blue-Violet Colour Pigment

For the composition formula Mo.aAl₂O₃bSiO₂.cL:fX, in which MO is SrO and CaO; L is ammonium chloride NH₄Cl, X is europium oxide Eu₂O₃, dysprosium oxide Dy₂O₃, and neodymium oxide Nd₂O₃ having the mole ratio of 1:2˜1.8, a=0.96, b=0.4, c=0.2, f=0.012.

The preparation and production method:

The following ingredients are weighed and mixed thoroughly:

SrCO₃ 5.73 g, CaCO₃ 35.00 g, Al₂O₃ extra fine powder 38.02 g, SiO₂ fine powder 9.33 g, (NH₄)₂ HPO₄ 10.26 g, Eu₂O₃ 0.34 g, Dy₂O₃ 0.73 g and Nd₂O₃ 0.59 g.

The resultant mixture is then put into a crucible to fire at a temperature of 1280° C. for 2 hours under a reducing atmosphere (filled with combined nitrogen with hydrogen), to yield the sinter. The sinter is then crushed, ground and graded, washed by alcohol and dried by heat to produce the photoluminescent pigment. The alkali earth aluminate-silicate photoluminescent material pigment manufactured by this method has a blue-violet colour, showing a luminescent intensity of 100 mcd/m² (1 minute after light excitation), with afterglow time of some 10 hours, its luminescent spectrum λₘₐₓ peaks at 440 nm, and appears neutral in water.

### EXAMPLE II

### The Blue Colour Pigment

For the composition formula MO.aAl₂O₃.bSiO₂.cL:fX, in which MO is SrO and MgO; L is ammonium chloride NH₄Cl, X is europium oxide Eu₂O₃ and dysprosium oxide Dy₂O₃ having the mole ratio of 1:5 a=0.01, b=1.5 c=0.35, f=0.008.

The preparation and production method:

The following ingredients are weighed and mixed thoroughly:

SrCo₃ 52.62 g, Mg07.20 g Al₂O₃ extra fine powder 0.36 g, SiO₂ fine powder 32.10 g, NH₄ Cl 6.67 g, Eu₂O₃, 0.19 g and Dy₂O₃ 0.86 g.

The resultant mixture is then put into a crucible to fire at a temperature of 1250° C. for 2.5 hours under a reducing atmosphere (filled with ammonia), to yield the sinter. The sinter is then crushed, ground and graded, washed by alcohol and dried by heat to produce the photoluminescent pigment. The alkali earth aluminate-silicate photoluminescent material pigment manufactured by this method has a blue colour, showing a luminescent intensity of 180 mcd/m² (1 minute after light excitation), with afterglow time of more than 12 hours, its luminescent spectrum λₘₐₓ peaks at 460 nm, and appears neutral in water.

### EXAMPLE III

### The Dark Blue-Green Colour Pigment

For the composition formula MO.aAl₂O₃.bSiO₂.cL:fX, in which MO is SrO and BaO; L is (NH₄)₂HPO₄ and B₂O₃ with mole radio 1:2; X is europium oxide Eu₂O₃ and dysprosium oxide Dy₂O₃ having the mole ratio of 1:0.9, a=1.38, b=0.04, c=0.25, f=0.01.

The preparation and production method:

The following ingredients are weighed and mixed thoroughly:

SrCO₃ 44.28 g, BaCO₃ 3.75 g, Al₂O₃ extra fine powder 44.90 g, SiO₂ fine powder 0.76 g, (NH₄)₂HPO₄ 2.1 g, H₃BO₃ 3.96 g, EU₂O₃ 0.67 g and Dy₂O₃ 0.48 g.

The resultant mixture is then put into a crucible to fire at a temperature of 1350° C. for 3 hours under a reducing atmosphere (filled with hydrogen), to yield the sinter. The sinter is then crushed, ground and graded, washed by alcohol and dried by heat to produce the photoluminescent pigment. The alkali earth aluminate-silicate photoluminescent material pigment manufactured by this method has a blue-green colour, showing a luminescent intensity of 1600 mcd/m² (1 minute after light excitation), with afterglow time of more than 12 hours, its luminescent spectrum λₘₐₓ peaks at 490 nm, and appears neutral in water.

### EXAMPLE IV

### The Light Blue-Green Colour Pigment

For the composition formula MO.aAl₂O₃.bSiO₂.cL:fX, in which MO is SrO, CaO and MgO, L is ammonium bromide NH₄Br, X is europium oxide Eu₂O₃, and dysprosium oxide Dy₂O₃ having the mole ratio of 1:5, a=0.01, b=1.0, c=0.35, f=0.008.

The preparation and production method:

The following ingredients are weighed and mixed thoroughly:

SrCo₃ 36.00 g, CaCO₃ 16.27 g, MgO 8.19 g, Al₂O₃ extra fine powder 0.41 g, SiO₂ fine powder 24.00 g, NH₄Br 13.93 g, Eu₂O₃ 0.22 g and Dy₂O₃ 0.98 g.

The resultant mixture is then put into a crucible to fire at a temperature of 1250° C. for 2 hours under a reducing atmosphere (filled with combined nitrogen with hydrogen), to yield the sinter. The sinter is then crushed, ground and graded, washed by alcohol and dried by heat to produce the photoluminescent pigment. The alkali earth aluminate-silicate photoluminescent material pigment manufactured by this method has a blue-green colour, showing a luminescent intensity of 1800 mcd/m² (1 minute after light excitation), with afterglow time of more than 10 hours, its luminescent spectrum λₘₐₓ peaks at 500 nm, and appears neutral in water.

### EXAMPLE V

### The Blue—Green Colour Pigment

For the composition formula MO.aAl₂O₃.bSiO₂.cL:fX, in which MO is SrO, L is ammonium chloride NH₄Cl and boric oxide B₂O₃ with mole ratio 1:02, X is europium oxide Eu₂O₃ and dysprosium oxide Dy₂O₃ having the mole ratio of 1:1, a=0.98, b=0.02, c=0.35, f=0.01.

The preparation and production method:

The following ingredients are weighed and mixed thoroughly:

SrCO₃ 54.29 g, Al₂O₃ extra fine powder 36.74 g, SiO₂ fine powder 0.44 g, NH₄Cl 4.92 g, H₃BO₃ 2.27 g, Eu₂O₃ 0.65 g and Dy₂O₃ 0.69 g.

The resultant mixture is then put into a crucible to fire at a temperature of 1300° C. for 3 hours under a reducing atmosphere (filled with combined nitrogen with hydrogen), to yield the sinter. The sinter is then crushed, ground and graded, washed by alcohol and dried by heat to produce the photoluminescent pigment. The alkali earth aluminate-silicate photoluminescent material pigment manufactured by this method has a blue-green colour, showing a luminescent intensity of 2300 mcd/m² (1 minute after light excitation), with afterglow time of more than 12 hours, its luminescent spectrum λₘₐₓ peaks at 510 nm, and appears neutral in water.

The invention is not restricted to the above-described embodiments but variations and modifications may be made without departing from the scope of the invention.

We claim:

1. An alkali earth aluminate-silicate photoluminescent material which is activated by rare-earth elements and which has the composition MO.aAl₂O₃bSiO₂cL:fx, in which MO is at least one oxide from the selection SrO, CaO, MgO and BaO; L is a mineraliser, X is a rare earth element activator; a, b, c and f are variable factors of Al₂O₃,SiO₂, mineraliser L and activator X and are presented in terms of mole and have a mole ratio relationship with MO in which the mole value of MO=1, the variable factors being:
0.3≦(a+b)≦3, b=(0.01˜2).(a),c=0.02˜0.5,f=0.001˜0.05.

2. An alkali earth aluminate-silicate photoluminescent material as claimed in claim 1, wherein the rare-earth element activator X is europium oxide and at least one oxide selected from a selection of dysprosium oxide, cerium oxide, neodymium oxide, praseodymium oxide, samarium oxide, terbium oxide, holmium oxide, erbium oxide, thulium oxide and ytterbium oxide; having the mole ratio relationship of 1:(0.5-5).

3. An alkali earth aluminate-silicate photoluminescent material as claimed in claim 1, wherein the rare-earth element activator X is europium oxide and dysprosium oxide having a mole ratio relationship of 1:(1˜2).

4. An alkali earth aluminate-silicate material as claimed in claim 1, wherein the mineraliser L is selected from at least one of alkali halide, an ammonium halide salt and ammonium phosphates.

5. An alkali earth aluminate-silicate material as claimed in claim 4, wherein the ammonium halide salt is selected from one of ammonium chloride, ammonium bromide and ammonium hydrogen phosphate.

6. A method of preparing an alkali earth aluminate-silicate photoluminescent material which is activated by rare-earth elements having the formula claimed in claim 1, said method including the steps of selecting and weighing an alkali earth metal carbonate or oxide, aluminium oxide or aluminium hydrate and silica powder, in which 0.3≦(a+b)≦3, b=(0.1˜2)a, c=0.02˜0.5, f=0.001˜0.05, together with elements for the mineraliser L and activator X mixing the ingredients and then putting the mixture into a crucible to fire at a temperature range of 1200 ˜1450° C. for 2-4 hours under a reducing atmosphere, to yield a sinter, the sintered material then being crushed, ground and graded, washed with de-ionised water, diluted hydrochloric acid solution or alcohol and dried by heat, finally to produce an alkali earth aluminate-silicate photoluminescent pigment which is activated by rare-earth elements.

7. A method as claimed in claim 6, wherein the reducing atmosphere is selected from at least one of gases or substances such as hydrogen, ammonia, nitrogen with hydrogen, and carbon granules.
